(19) United States
(12) Patent Application Publication
(10) Pub. No.: US 2025/0083969 A1
(43) Pub. Date: Mar. 13, 2025

(54) PROCESS TO PRODUCE BATTERY GRADE LITHIUM HYDROXIDE MONOHYDRATE WITH LOW CONTENT OF CARBONATE

(71) Applicants: Claudia Pudack, Zurich (CH); Marcus de Castro Carvalho Simoes, Heidenrod (DE); Munier Hijazi, Neu-Anspach (DE); Thomas Josef Schaffrath, Billerbeck, NRW (DE)

(72) Inventors: Claudia Pudack, Zurich (CH); Marcus de Castro Carvalho Simoes, Heidenrod (DE); Munier Hijazi, Neu-Anspach (DE); Thomas Josef Schaffrath, Billerbeck, NRW (DE)

(21) Appl. No.: 18/828,960

(22) Filed: Sep. 9, 2024

Related U.S. Application Data
(60) Provisional application No. 63/581,920, filed on Sep. 11, 2023.

(51) Int. Cl. C01D 15/02; B01D 9/00; C01D 1/30; C01D 1/42; H01M 4/48

(52) U.S. Cl. CPC C01D 15/02; B01D 9/0004; C01D 1/30; C01D 1/42; C01P 2006/40; H01M 4/48

(57) ABSTRACT

A process to produce battery grade lithium hydroxide monohydrate with low content of carbonate from an impure lithium feed by forming a concentrated lithium hydroxide solution that is saturated or nearly saturated with lithium hydroxide monohydrate, removing at least some lithium carbonate from the solution, crystallizing the lithium hydroxide monohydrate, and separating the crystallized lithium hydroxide monohydrate from the solution.

This application claims the benefit of U.S. Provisional Application No. 63/581,920, filed Sep. 11, 2023, which is incorporated herein by reference in its entirety.

### FIELD OF THE INVENTION

The present invention relates to a process to produce battery grade lithium hydroxide monohydrate with low content of carbonate.

### BACKGROUND

Lithium-ion batteries are rechargeable batteries that are commonly used in a wide range of electronic devices, from smartphones and laptops to electric vehicles and renewable energy storage systems. In a lithium-ion battery, lithium ions move between the positive and negative electrodes (cathode and anode) during the charging and discharging processes. Lithium hydroxide may be used for the cathode active material (CAM). Also, the movement of lithium ions between positive and negative electrodes is facilitated by an electrolyte. A type of electrolyte used is lithium sulfide, a solid. As precursor for lithium sulfide production (solid), the carbonate content in the lithium hydroxide are preferably as low as possible.

The presence of carbonate in the lithium hydroxide can be detrimental. A low carbonate content may contribute to improved battery performance, safety, cycle life, efficiency, energy density, and manufacturing consistency. These factors can be important for the successful development and deployment of high-performance lithium-ion batteries in various applications.

Accordingly, it may be desirable to have an efficient process to produce lithium hydroxide monohydrate with a low carbonate content.

### SUMMARY

Exemplary embodiments of a process to produce battery grade lithium hydroxide monohydrate with low content of carbonate can substantially obviate one or more of the problems due to limitations and disadvantages of the related art.

Additional features and advantages of the process described herein will be set forth in the description which follows, and in part will be apparent from the description, or may be learned by practice of the process. The objectives and other advantages of the process will be realized and attained by the structure particularly pointed out in the written description and claims hereof as well as the appended drawings.

In examples, provided may be a process for producing lithium hydroxide monohydrate that may include forming a concentrated lithium hydroxide solution saturated or nearly saturated with lithium hydroxide monohydrate, removing at least some lithium carbonate from the concentrated lithium hydroxide solution via a first solid-liquid separation process, crystallizing the lithium hydroxide monohydrate in the concentrated lithium hydroxide solution, and separating the crystallized lithium hydroxide monohydrate from the concentrated lithium hydroxide solution via a second solid-liquid separation process.

In examples, forming the concentrated lithium hydroxide solution may include providing a lithium containing feed.

In examples, the lithium containing feed may include providing a lithium hydroxide solution may include a crude lithium hydroxide, a technical grade lithium hydroxide, an industrial grade lithium hydroxide, a battery grade lithium hydroxide, a primary grade lithium hydroxide, a lithium hydroxide containing impurities, or any combination thereof.

In examples, the lithium containing feed may include providing a lithium carbonate may include a crude lithium carbonate, a technical grade lithium carbonate, an industrial grade lithium carbonate, a primary grade lithium carbonate, a battery grade lithium carbonate, a lithium carbonate containing impurities, or any combination thereof.

In examples, the process may include a dissolution of the lithium carbonate to yield a lithium hydroxide solution. In examples, the dissolution may include reacting the lithium carbonate with an acid or an alkaline earth hydroxide.

In examples, the dissolution of the lithium carbonate may include reacting the lithium carbonate with an acid may include sulfuric acid to produce a lithium sulfate solution.

In examples, the process may include reacting the lithium sulfate solution with a hydroxide to form a lithium hydroxide solution. In examples, the hydroxide may include sodium hydroxide, and the process may include producing aqueous sodium sulfate, conducting a cooling crystallization to crystallize the aqueous sodium sulfate to yield Glauber Salt, and separating the Glauber Salt from the lithium hydroxide solution via a third solid-liquid separation process to yield a purified lithium hydroxide solution. In examples, forming the concentrated lithium hydroxide solution saturated or nearly saturated with lithium hydroxide monohydrate may include concentrating the purified lithium hydroxide solution. In examples, concentrating the purified lithium hydroxide solution may include an evaporative process.

In examples, the hydroxide may include barium hydroxide, and the process may include producing solid barium sulfate, and separating the solid barium sulfate from the lithium hydroxide solution via a second solid-liquid separation process to yield a purified lithium hydroxide solution. In examples, forming the concentrated lithium hydroxide solution saturated or nearly saturated with lithium hydroxide monohydrate may include concentrating the purified lithium hydroxide solution yield from one or more of the above processes. In examples, concentrating the purified lithium hydroxide solution may include an evaporative process.

In examples, the dissolution of lithium carbonate may include reacting the lithium carbonate with an alkaline earth hydroxide to form a lithium hydroxide solution. In examples, the alkaline earth hydroxide may include calcium hydroxide, the process may include reacting the calcium hydroxide to form solid calcium carbonate in the lithium hydroxide solution and removing the solid calcium carbonate via a third solid-liquid separation. In examples, the process may include ion exchange treating the lithium hydroxide solution previously provided or formed to yield a purified lithium hydroxide solution. In examples, forming the concentrated lithium hydroxide solution saturated or nearly saturated with lithium hydroxide monohydrate may include concentrating the purified lithium hydroxide solution by an evaporative process.

In examples, the ion exchange to yield a purified lithium hydroxide solution may include contacting the lithium hydroxide solution with a first resin capable of removing carbonates, sulfates, or both, and then optionally containing the lithium hydroxide solution with a second resin capable of removing calcium, magnesium, multivalent cations, or a combination thereof.

In examples, prior to crystallizing the lithium hydroxide monohydrate, the process may include purifying the concentrated lithium hydroxide solution saturated or nearly saturated with lithium hydroxide monohydrate after removal of the at least some lithium carbonate by ion exchange by contacting the concentrated lithium hydroxide solution saturated or nearly saturated with lithium hydroxide monohydrate with a third resin capable of removing calcium, magnesium, multivalent cations, or a combination thereof.

In examples, the ion exchange to yield a purified lithium hydroxide solution may include a first ion exchange treatment that may include containing the lithium hydroxide solution with a first resin capable of removing calcium, magnesium, multivalent cations, or a combination thereof. In examples, the process may include concentrating the purified lithium hydroxide solution, contacting the lithium hydroxide solution that has been concentrated with calcium hydroxide to react with lithium carbonate present and form calcium carbonate solids and additional aqueous lithium hydroxide, and removing at least some of the formed calcium carbonate and remaining lithium carbonate by a fourth solid-liquid separation. In examples, the process may include further purifying the lithium hydroxide solution after the fourth solid-liquid separation by a second ion exchange treatment may include contacting the lithium hydroxide solution with a second resin capable of removing calcium, magnesium, multivalent cations, or a combination thereof to yield a purified lithium hydroxide solution, and forming the concentrated lithium hydroxide solution saturated or nearly saturated with lithium hydroxide monohydrate may include concentrating the lithium hydroxide solution after this second ion exchange treatment by an evaporative process.

In examples, providing a lithium containing feed may include providing a lithium sulfate solution. In examples, the process may include reacting the lithium sulfate solution with a hydroxide. In examples, the hydroxide may be sodium hydroxide and the process may include producing aqueous sodium sulfate, conducting a cooling crystallization process to crystallize the aqueous sodium sulfate to yield Glauber Salt, and separating the Glauber Salt from the lithium hydroxide solution via a third solid-liquid separation process to yield a purified lithium hydroxide solution. In examples, the hydroxide may include barium hydroxide, and the process may include producing solid barium sulfate, and separating the solid barium sulfate from the lithium hydroxide solution via a second solid-liquid separation process to yield a purified lithium hydroxide solution. In examples, forming the concentrated lithium hydroxide solution saturated or nearly saturated with lithium hydroxide monohydrate may include concentrating the purified lithium hydroxide solution. In examples, concentrating the lithium hydroxide solution may include an evaporative process.

In examples, providing a lithium containing feed may include providing a lithium chloride may include a crude lithium chloride, a technical grade lithium chloride, an industrial grade lithium chloride, a primary grade lithium chloride, a battery grade lithium chloride, a lithium chloride containing impurities, or any combination thereof. In examples, the process may include contacting the lithium containing feed with hydrochloric acid and increasing the temperature of the solution and yield a lithium chloride solution. In examples, providing a lithium containing feed may include a dissolution of the lithium carbonate, wherein the dissolution may include reacting the lithium carbonate with an acid may include hydrochloric acid to form a lithium chloride solution. In examples, the process may include contacting the lithium chloride solution with a hydroxide. In examples, the hydroxide may be selected from sodium hydroxide or calcium hydroxide. In examples, the process may include removing precipitates from the lithium chloride solution after contacting the hydroxide by a third solid-liquid separation process. In examples, the process may include purifying the lithium chloride solution after the third solid-liquid separation process to yield a purified lithium chloride solution. In examples, purifying the lithium chloride solution may include a first purification by a first ion exchange may include contacting the lithium chloride solution with a first resin capable of removing calcium, magnesium, multivalent cations, or a combination thereof, and a second purification may include a second ion exchange may include contacting the lithium chloride solution after the first purification with a second resin capable of removing carbonates, sulfates, or both. In examples, the process may include concentrating the purified lithium chloride solution to yield a concentrated lithium chloride solution. In examples, concentrating the purified lithium chloride solution may include reverse osmosis, evaporation, or both. In examples, the process may include converting the concentrated lithium chloride solution into the concentrated lithium hydroxide solution by electrolysis, electrodialysis, or both. In examples, forming the concentrated lithium hydroxide solution saturated or nearly saturated with lithium hydroxide monohydrate may include concentrating the concentrated lithium hydroxide solution formed by electrolysis, electrodialysis, or both.

In examples, crystallizing the lithium hydroxide monohydrate may include concentrating the concentrated lithium hydroxide solution by evaporation.

In examples, crystallizing the lithium hydroxide monohydrate may include cooling crystallization. In examples, forming a concentrated lithium hydroxide solution saturated or nearly saturated with lithium hydroxide monohydrate may include conducting an evaporative process. In examples, the process may include employing a heat pump arranged to provide cooling for the cooling crystallization and heating for the evaporative process.

In examples, the process may include one or more purifications of the crystallized lithium hydroxide monohydrate separated from the concentrated lithium hydroxide solution.

In examples, the process may include drying and packaging the crystallized lithium hydroxide monohydrate separated from the concentrated lithium hydroxide solution.

In examples, the process may include recycling the concentrated lithium hydroxide solution after separation of the crystallized lithium hydroxide monohydrate to produce additional lithium hydroxide monohydrate.

In examples, provided is lithium hydroxide monohydrate formed by any of the above process, wherein the lithium hydroxide monohydrate may include less than 2000 ppm lithium carbonate.

Any combination of the above-listed features may be implemented as described in more detail in the detailed description without departing from the spirit or scope of this disclosure. It is to be understood that both the foregoing general description and the following detailed description are exemplary and explanatory and are intended to provide further explanation of the disclosure as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIGS. 1-4 illustrate flow diagrams of examples of processes to produce battery grade lithium hydroxide monohydrate with low content of lithium carbonate.

### DETAILED DESCRIPTION

As discussed earlier, a low carbonate content lithium hydroxide may be desirable for the construction of lithium batteries. In examples, herein is described a process to produce battery grade lithium hydroxide monohydrate. In examples, the produced battery grade lithium hydroxide monohydrate may have a low content of carbonate.

In examples, the process as described may include one or more of lithium processing, lithium refining and purification, lithium hydroxide monohydrate production, evaporation and crystallization, softening, and ion exchange.

In examples, disclosed is a process to produce battery grade lithium hydroxide monohydrate that may include a low content of carbonate. In examples, the process may include one or more of leaching, purification, concentration, and crystallization from a crude feed.

In examples, a low carbonate content refers to a carbonate content that is less than 2000 ppm based on the total weight of the lithium hydroxide monohydrate material. In examples, lithium hydroxide monohydrate with low carbonate content means a lithium hydroxide monohydrate in which carbonate is present is less than 2000 ppm. For example, the carbonate content of the lithium hydroxide monohydrate with low carbonate as can be achieved by the process described herein may be less than 2000 ppm, less than 1500 ppm, less than 1000 ppm, less than 500 ppm, or less than 100 ppm. This is distinguishable from typical battery grade lithium hydroxide monohydrate that may otherwise contain up to about 4700 ppm of carbonates.

In examples, a low carbonate content may be desirable for the conversion of lithium hydroxide monohydrate into lithium sulfide.

The process as disclosed herein may yield a lower carbonate product that may be utilized in any applications where carbonates are undesirable.

In examples, the process as described herein may include crystallizing lithium hydroxide monohydrate from a concentrated lithium hydroxide solution that is saturated or nearly saturated with lithium hydroxide monohydrate and contains low levels of lithium carbonate. In examples, the concentrated lithium hydroxide solution may be formed to contain a low concentration of lithium carbonate. In examples, the concentrated lithium hydroxide solution may be purged of lithium carbonate prior to crystallization of the lithium hydroxide monohydrate. In examples, the process as described herein may include crystallizing lithium hydroxide monohydrate from a concentrated lithium hydroxide solution that is saturated or nearly saturated with lithium hydroxide monohydrate and contains Li₂CO₃ in a concentration of no more than 2000 ppm or 0.2 wt %, for example, no more than 1500 ppm or 0.15 wt %, for example, no more than 1000 ppm or 0.1 wt %, for example, no more than 500 ppm or 0.05 wt %, for example, no more than 100 ppm or 0.01 wt %. For purposes of this description, a solution is described as “saturated” with lithium hydroxide monohydrate to indicate that it exhibits 100% saturation of lithium hydroxide monohydrate. For purposes of this description, a solution is described as “nearly saturated” with lithium hydroxide monohydrate to indicate that the level of saturation of the lithium hydroxide monohydrate in the solution is at least 80% saturation, at least 85% saturation, at least 90% saturation, at least 95% saturation, at least 97% saturation, or at least 99%.

In examples, the process as described herein may include removal of carbonate at saturation of or just before saturation of lithium hydroxide monohydrate from a lithium hydroxide solution. In examples, the process as described herein may obtain lithium hydroxide monohydrate from a lithium hydroxide solution by a concentration process such as, for example, evaporation. In examples, a lithium hydroxide solution may be heated to evaporate the water from the solution. In examples, the solution may be monitored for the formation of lithium carbonate in the solution as it is concentrated. In examples, at or just prior to reaching saturation of lithium hydroxide monohydrate from the lithium hydroxide through concentration, the process as described herein may include an extraction of the lithium carbonate formed. In examples, the extraction of lithium carbonate may be carried out by a solid-liquid separation process or other suitable filtration.

In examples, the lithium hydroxide monohydrate may then be obtained from a low carbonate containing concentrated lithium hydroxide solution saturated or nearly saturated with lithium hydroxide monohydrate by concentrating the solution by an evaporative process and/or by a cooling crystallization process.

For purposes of this description “just before reaching saturation” when referencing the stopping point at which to remove the lithium carbonate from the concentrated LiOH solution is used to refer to the state at which at least 80% saturation, at least 85% saturation, at least 90% saturation, at least 95% saturation, at least 97% saturation, or at least 99% saturation of lithium hydroxide monohydrate is reached in the concentrated solution. For purposes of this description “at saturation” when referencing the stopping point at which to remove the lithium carbonate from the concentrated LiOH solution is used to refer to the state at which 100% saturation of lithium hydroxide monohydrate is reached in the concentrated solution.

In examples, the lithium hydroxide monohydrate obtained either by continued evaporation and/or by cooling crystallization after the separation of the lithium carbonate will contain less carbonate impurities than lithium hydroxide monohydrate obtained by conventional processes. In examples, a cooling crystallization process may lead to lower carbonate content in the lithium hydroxide monohydrate than continued evaporation.

In examples, the process as described herein may include obtaining a lithium hydroxide solution that can be used to obtain lithium hydroxide monohydrate. In examples, the lithium hydroxide solution may be obtained from a crude feed, or other feed containing impurities.

In examples, the starting feed may include lithium carbonate, such as a crude lithium carbonate. In examples, the process as described herein may include a dissolution of crude lithium carbonate. In examples, the dissolution of crude lithium carbonate may be performed with an acid and/or with an alkaline earth hydroxide.

In examples, a lithium carbonate feed may be used to form a lithium hydroxide feed from which to obtain lithium hydroxide monohydrate. In examples, a lithium hydroxide solution may be obtained by reacting a lithium carbonate feed first with an acid to form lithium salt that can then be reacted with a metal hydroxide. In examples, the acid may be hydrochloric acid (HCl) or sulfuric acid (H₂SO₄). In examples, a lithium hydroxide solution may be obtained from a lithium carbonate feed by direct reaction with an alkaline earth hydroxide. In examples, an alkaline earth hydroxide may be calcium hydroxide (Ca(OH)₂).

In examples, the starting feed may already include a lithium hydroxide solution. In examples, a starting lithium hydroxide solution may have any level of impurity. In examples, the lithium hydroxide solution may include lithium hydroxide monohydrate, lithium hydroxide anhydrous, or both. In examples, the starting hydroxide solution may be a crude lithium hydroxide solution, a technical grade lithium hydroxide solution, an industrial grade lithium hydroxide solution, a primary grade lithium hydroxide solution, a battery grade lithium hydroxide solution as may be produced by other processes, or any mixture thereof.

In examples, the process may include an ion exchange treatment. In examples, the ion exchange may be carried out when the dissolution of crude lithium carbonate is performed with an acid and/or with an alkaline earth hydroxide. In examples, the ion exchange may be employed to remove the carbonates and sulfates, and/or to remove cations such as calcium, magnesium and other multivalent cations.

Reference will now be made in detail to an embodiment of the present disclosure, examples of which are illustrated in the accompanying drawings.

Unless defined otherwise, all technical and scientific terms used herein have the same meaning as is commonly understood by one of skill in the art to which the disclosure belongs. All patents, patent applications, published applications and publications, websites and other published materials referred to throughout the entire disclosure herein, unless noted otherwise, are incorporated by reference in their entirety. Where there is a plurality of definitions for terms herein, those in this section prevail. Where reference is made to a URL or other such identifier or address, it is understood that such identifiers can change and information on the internet can come and go, but equivalent information can be found by searching the internet. Reference thereto evidences the availability and public dissemination of such information.

As used herein, the singular forms “a”, “an” and “the” include plural referents unless the context clearly dictates otherwise.

The terms first, second, third, etc. as used herein can describe various elements, components, regions, layers and/or sections, these elements, components, regions, layers and/or sections should not be limited by these terms. These terms may be only used to distinguish one element, component, region, layer or section from another region, layer, or section. Terms such as “first”, “second”, and other numerical terms when used herein do not imply a sequence or order unless clearly indicated by the context. Thus, a first element, component, region, layer, or section discussed below could be termed a second element, component, region, layer, or section without departing from the teachings of the example embodiments.

As used herein, ranges and quantities can be expressed as “about” a particular value or range. “About” also includes the exact amount. Hence “about 5 percent” means about 5 percent in addition to 5 percent. The term “about” means within typical experimental error for the application or purpose intended.

As used herein, “and/or” includes any and all combinations of one or more of the associated listed items.

As used herein, a “combination” refers to any association between two items or among more than two items. The association can be spatial or refer to the use of the two or more items for a common purpose.

As used herein, “comprising” and “comprises” are to be interpreted to mean “including but not limited to” and “includes but not limited to”, respectively.

As used herein, “optional” or “optionally” means that the subsequently described event or circumstance does or does not occur, and that the description includes instances where the event or circumstance occurs and instances where it does not. For example, an optional component in a system means that the component may be present or may not be present in the system.

As used herein, “substantially” means “being largely but not wholly that which is specified.”

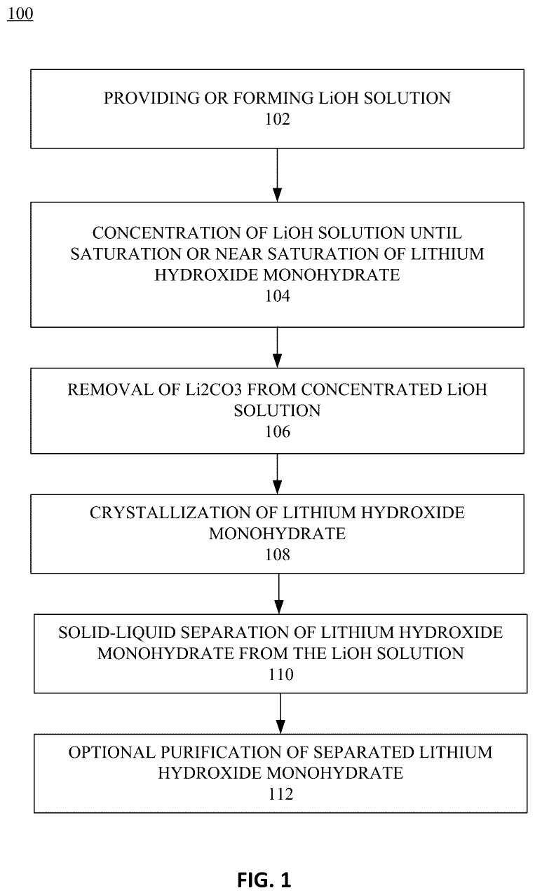

FIG. 1 illustrates a flow diagram of an example of a process 100 to produce low carbonate battery grade lithium hydroxide monohydrate.

In examples, as shown in FIG. 1, a low carbonate battery grade lithium hydroxide monohydrate may be obtained from a concentrated lithium hydroxide solution saturated or nearly saturated with lithium hydroxide monohydrate and removing at least some of the lithium carbonate prior to crystallization of the lithium hydroxide monohydrate.

In examples, the process may include forming a concentrated lithium hydroxide solution saturated or nearly saturated with lithium hydroxide monohydrate, with low level of lithium carbonate. In examples, at least a portion of lithium carbonate is removed from the concentrated lithium hydroxide solution that is saturated or nearly saturated with lithium hydroxide monohydrate.

In examples, as illustrated at 102, a LiOH solution may be provided or it may be produced as explained in more detail later. In examples, the LiOH solution may be any LiOH solution with any concentration of impurities. In examples, the LiOH solution may be produced. In examples, the LiOH solution may be produced from lithium feed. In examples, as described later, the lithium feed may include lithium carbonate and/or lithium sulfate. In examples, the LiOH solution may be provided. In examples, the provided LiOH solution may be a crude LiOH solution, a technical grade LiOH solution, an industrial grade LiOH solution, a primary grade LiOH solution, a battery grade LiOH solution or any mixture thereof.

In examples, at 104, the process may include concentrating the LiOH solution. In examples, concentration of the LiOH solution may be by evaporation. In examples, the LiOH solution may be heated up to boiling point and evaporated until saturation or almost complete saturation of lithium hydroxide monohydrate is reached. In examples, evaporation may be carried out at temperature range of 110-120° C., at atmospheric pressure. In examples, the concentration process may involve multiple stages of evaporation. In examples, where multiple stages of evaporation are involved or under vacuum, the process may be carried out at a temperature ranging from 30 to 120° C.

In examples, build-up of impurities in the process may be controlled by stopping the concentration (e.g., evaporation) at saturation of or just before reaching saturation of lithium hydroxide monohydrate, and removing the impurities precipitated during the concentration process before proceeding with the crystallization of the lithium hydroxide monohydrate. In examples, the impurities may be removed after the concentration process is carried out until at least 80% saturation, at least 85% saturation, at least 90% saturation, at least 95% saturation, at least 97% saturation, at least 99%, or 100% saturation of lithium hydroxide monohydrate in the solution is achieved.

In examples, as a result of the concentration process at 104, solid impurities may be precipitated. In examples, the solid impurities that precipitate may include Li₂CO₃. Other metal impurities may also be precipitate.

$$x ( M = Fe , Al , Co , Cu , Ni , Mn , Zn , As , … ) + {y OH}^{-} ( aq ) \to {M}_{x} {OH}_{y} ( s ) or {SiO}_{2} ( s ) {Li}_{2} {CO}_{3} ( aq ) \to {Li}_{2} {CO}_{3} ( s )$$

In examples, the concentration process may be followed by a removal of the precipitated impurities including the precipitated carbonates. In examples, at 106 solid-liquid separation may be carried out after the concentration. Solid liquid separation may be carried out in any suitable manner. Non-limiting examples of solid-liquid separation may include using one or more filters, thickeners, or combinations of different solid-liquid separation technologies.

In examples, the separated solids may be disposed of, further processed, or recycled to produce additional lithium hydroxide solution.

In examples, at 108 the concentrated lithium hydroxide solution saturated or nearly saturated with lithium hydroxide monohydrate, wherein the concentrated lithium hydroxide solution from which at least some of lithium carbonate has been removed from 106 may be further concentrated or undergo cooling crystallization to obtain lithium hydroxide monohydrate salt. In examples, additional concentration may be carried out via additional evaporation. By conducting further evaporation and/or cooling crystallization, it may be possible to crystallize the saturated lithium hydroxide monohydrate in the solution.

$$LiOH ( aq ) + H 2 O \to LiOH * H 2 O ( s )$$

In examples, cooling crystallization may result in lower carbonate content than crystallization by additional evaporation. This is because by carrying out additional evaporation, additional Li₂CO₃ may form. In examples, cooling crystallization is carried out at temperatures sufficiently low at which Li₂CO₃ can remain soluble. This may result in obtaining a precipitate that is mostly lithium hydroxide monohydrate. In examples, where lithium hydroxide monohydrate is obtained via cooling crystallization, the final cooling temperature may be about 23-40° C.

In examples, cooling crystallization may also be advantageous from an energy consumption process as it does not require additional heating. In examples, cooling crystallization may be advantageous because it avoids the need of passing the solution through a heat exchanger that would require cleaning. In examples, cooling crystallization may allow energy integration via a heat pump. In examples, the cooling crystallization will be carried out at a temperature that is lower than the temperature at which the LiOH solution is initially concentrated via evaporation. Accordingly, in examples, a heat pump may be provided to heat the solution during concentration by evaporative process while cooling the solution during cooling crystallization. In this manner, the utilization of a heat pump for energy integration between the concentration evaporative process and the cooling crystallization may lead to reduced energy consumption. Cooling crystallization may also be advantageous in that it may result in a crystallized lithium hydroxide monohydrate with less moisture than compared to crystallized lithium hydroxide monohydrate obtained by evaporation.

In examples, by removing the Li₂CO₃ prior to crystallizing the lithium hydroxide monohydrate, it is possible to obtain a battery grade lithium hydroxide monohydrate with a carbonate content that is less than 2000 ppm, less than 1500 ppm, less than 1000 ppm, less than 500 ppm, or less than 100 ppm.

In examples, the crystallized lithium hydroxide monohydrate may be separated from the solution, washed and/or purified, dried, and packaged.

In examples, at 110, the crystallized lithium hydroxide monohydrate salt may be removed from the solution via any suitable solid-liquid separation. In examples, the solid-liquid separation may be performed using one or more hydrocyclone(s) in combination with one or more centrifuge(s). In examples, the solid-liquid separation may include washing of a filter cake obtained. In examples, the remaining solution after filtration of the crystallized lithium hydroxide monohydrate may be recycled into the process to recapture any left over lithium.

In examples, at 112, purification of the crystallized lithium hydroxide monohydrate may be by either one or more redissolution and recrystallization processes and/or by one or more repulping and solid-liquid separation processes until the product meets the desired battery grade specifications. In examples, the redissolution may be carried out with pure water that is free or nearly free of CO₂.

In examples, the concentrated lithium hydroxide solution formed at 102 from which the lithium hydroxide monohydrate is ultimately obtained may be formed or produced from a lithium feed. In examples, the lithium feed may include lithium hydroxide. In examples, the lithium feed may include lithium carbonate. In examples, the lithium feed may include lithium sulfate. In examples, the lithium feed may include lithium chloride.

In examples, combining the production of a concentrated lithium hydroxide solution with the formation of lithium hydroxide monohydrate with a low carbonate content as previously described may be advantageous as it may provide a means to transport the raw material more easily. For example, lithium carbonate and/or lithium sulfate may be more easily transported than lithium hydroxide solution or lithium hydroxide monohydrate or lithium hydroxide anhydrous.

In examples, the lithium feed starting material may include any concentration of impurities. In examples, the lithium feed may be a crude feed, a technical grade feed, an industrial grade feed, a battery grade feed, a primary grade feed, or any mixture thereof. For example, if the lithium feed is a lithium hydroxide solution it may be crude lithium hydroxide, technical grade lithium hydroxide, industrial grade lithium hydroxide, battery grade lithium hydroxide, primary grade lithium hydroxide, or any mixture thereof. For example, if the lithium feed is lithium carbonate it may be crude lithium carbonate, technical grade lithium carbonate, industrial grade lithium carbonate, battery grade lithium carbonate, primary grade lithium carbonate, or any mixture thereof. For example, if the lithium feed is lithium sulfate it may be crude lithium sulfate, technical grade lithium sulfate, industrial grade lithium sulfate, battery grade lithium sulfate, primary grade lithium sulfate, or any mixture thereof. For example, if the lithium feed is lithium chloride it may be crude lithium chloride, technical grade lithium chloride, industrial grade lithium chloride, battery grade lithium chloride, primary grade lithium chloride, or any mixture thereof.

In examples, a lithium hydroxide solution may be obtained from the dissolution of a lithium feed material such as lithium carbonate or lithium sulfate. In examples, the dissolution of lithium feed material may be carried out via an acid or using an alkaline earth hydroxide.

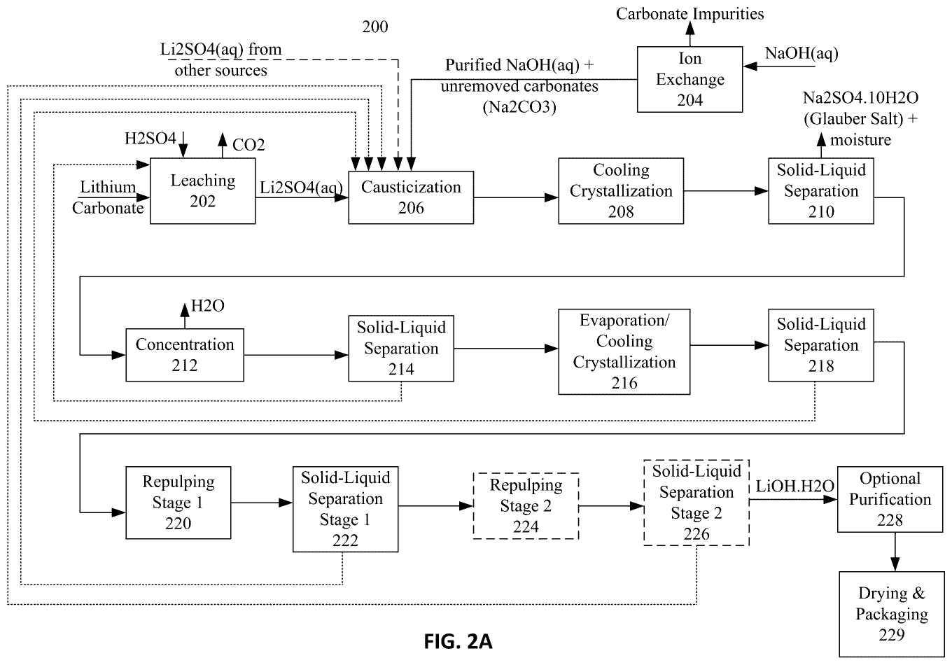

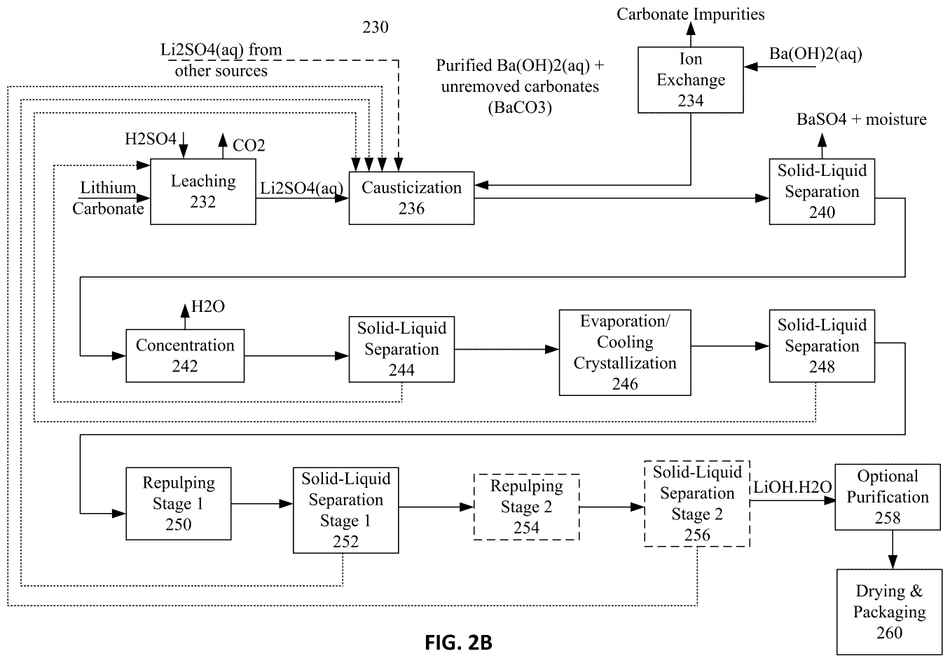

FIGS. 2A and 2B illustrate examples of a process flow diagram for producing lithium hydroxide monohydrate starting with a lithium feed of lithium carbonate and/or lithium sulfate. In examples, as shown, if starting with lithium carbonate, the dissolution of crude lithium carbonate may be carried out using an acid such as sulfuric acid. In examples, this process may be carried out as illustrated in FIGS. 2A and 2B.

FIG. 2A illustrates an example process 200. In examples, in process 200 at 202, crude lithium carbonate may undergo dissolution by contact with 0 to 10% excess sulfuric acid at a temperature ranging from 70° C. to 90° C., at atmospheric pressure. In examples, this process may be carried out in any suitable equipment, for example a continuous stirred tank reactor. Doing this step at high temperatures can improve or ensure that CO₂ solubility in solution may be as low as possible. The reaction mechanism is illustrated by the following equation.

$${Li}_{2} {CO}_{3} ( s ) + {H}_{2} {SO}_{4} ( aq ) \to {LiSO}_{4} ( aq ) + {CO}_{2} ( g ) + {H}_{2} O$$

In examples, the reaction may result in the production of Li₂SO₄. In examples, the reaction is carried out to achieve a concentration of Li₂SO₄ that avoids or limits the crystallization of Li₂SO₄*H₂O. In examples, the maximum concentration of Li₂SO₄ may be about 250 g/kg H₂O.

In examples, in process 200, the dissolution at 202 may be omitted if the starting lithium feed is already a Li₂SO₄ solution instead of lithium carbonate. Solutions containing dissolved Li₂SO₄ may be available as an intermediate product of lithium leaching from hard rock, such as spodumene. In examples, additional Li₂SO₄ solution may optionally be added at or just before 206 to the Li₂SO₄ solution produced at 202.

In examples, the solution containing dissolved Li₂SO₄ may be reacted by causticizing with a hydroxide to yield a LiOH solution. In examples, the hydroxide can be any suitable material that can react with the lithium sulfate to yield LiOH solution. In examples, the hydroxide may be NaOH, or Ba(OH)₂.

FIG. 2A illustrates a process in which the hydroxide used is sodium hydroxide (NaOH). In examples, at 206, the sodium hydroxide may be added to the lithium sulfate solution to yield sodium sulfate and an LiOH solution as shown by the following equation. In examples, the reaction may be carried out at a temperature ranging from 70° C. to 90° C., at atmospheric pressure. In examples, it may not be required to add an excess of sodium hydroxide.

$${Li}_{2} {SO}_{4} ( aq ) + 2 NaOH ( aq ) \to {Na}_{2} {SO}_{4} ( aq ) + 2 LiOH ( aq )$$

In examples, at 204 an ion exchange treatment may be carried out using one or more resins to remove carbonates and purify the sodium hydroxide solution prior to its utilization in the causticization process at 206. In examples, the ion exchange treatment may include the use of any suitable resin, in examples, the resin may include a styrene resin as a polystyrene-divinylbenzene resin.

In examples, it may be possible to introduce at 206 one or more recycle solutions produced at 218, 222 and/or 226 described below.

In examples, the yield of the causticization at 206 may include a stream containing aqueous sodium sulfate (Na₂SO₄ (aq)) at a concentration of up to about 288 g/kg H₂O, and LiOH (aq) at a concentration of up to about 172 g/kg H₂O.

In examples, at 208 and 210, the product effluent from 206 may be processed to remove at least a portion of the Na₂SO₄. In examples, the aqueous Na₂SO₄ may be removed by precipitating Glauber Salt (Na₂SO₄.10H₂O) at 208 and then removing the precipitant via any suitable solid-liquid separation at 210. In examples, the precipitation of Glauber Salt may be triggered by cooling crystallization at temperature ranging from about 0° C. to 7° C.

$${Na}_{2} {SO}_{4} ( aq ) + 10 {H}_{2} O \to {Na}_{2} {SO}_{4} * 10 {H}_{2} O ( s )$$

In examples, after crystallization, the Na₂SO₄ (aq) content remaining in solution may be in the range of about 106-142 g/kg H₂O (depending on the final temperature). The concentration of the LiOH (aq) in the resulting solution may be as high as 200 g/kg H₂O.

In examples, at 210 a solid-liquid separation of Glauber Salt may be carried out to remove the Glauber Salt from the solution. Any suitable solid-liquid separation may be applied. In examples, the solid-liquid separation may be a filtration process. In examples, the filtration may be carried out using a centrifuge. In examples, the residual moisture in the Glauber Salt cake removed from the solution after solid-liquid separation may be in the range of about 3-10% based on the total mass of separated cake.

In examples, the resulting LiOH solution after the removal of the Glauber Salt may be used to produce lithium hydroxide monohydrate as previously described with reference to FIG. 1. In examples, at 212, the LiOH solution may be concentrated. As previously described, in examples, concentration may be accomplished by evaporation. In examples, the evaporation may be carried out at a temperature in the range of about 110-120° C. In examples, the concentration may be carried out at atmospheric pressure, using any suitable equipment. In examples, where multiple stages of evaporation are involved or under vacuum, the temperature range may range from about 30 to about 120° C. In examples, the evaporation may include heating the LiOH solution produced after the separation of the Glauber salt at 210 to boiling point and evaporated until reaching saturation of or just before reaching saturation of lithium hydroxide monohydrate in the concentrated solution as previously described. As a result of this concentration process, solid impurities including Li₂CO₃ may be precipitated by the following mechanisms.

$$x ( M = Fe , Al , Co , Cu , Ni , Mn , Zn , As , … ) + {y OH}^{-} ( aq ) \to {M}_{x} {OH}_{y} ( s ) or {SiO}_{2} ( s )$$

$${Li}_{2} {CO}_{3} ( aq ) \to {Li}_{2} {CO}_{3} ( s )$$

In examples, at 214 a solid-liquid separation may be carried out after completion of the concentration at 212. As previously described, the solid-liquid separation may be carried out by any suitable means. In examples, the solid-liquid separation may be carried out using one or more filters, thickeners, centrifuges, or any combinations of different solid-liquid separation technologies. In examples, the separated solids from 214 may be recycled to 202 so that the precipitated Li₂CO₃ can undergo dissolution again to produce more LiOH. In examples, this recycle may enhance the recovery of lithium in the process. In examples, build-up of recycled impurities in the process may be controlled by stopping the evaporation just before reaching saturation or at saturation of the lithium hydroxide monohydrate, and removing impurities formed before proceeding with the crystallization of lithium hydroxide monohydrate. Other methods may also be used.

At 216, the saturated lithium hydroxide monohydrate in the concentrated solution may be crystallized. In examples, as previously discussed, the crystallization may be achieved either by resuming the concentration process and continuing the evaporation or by cooling crystallization. If cooling crystallization is utilized the final cooling temperature may be about 23° C. to 40° C. In examples, the crystallization follows the following mechanism.

$$LiOH ( aq ) + {H}_{2} O \to LiOH * {H}_{2} O ( s )$$

In examples, after the crystallization of the lithium hydroxide monohydrate, the remaining solution may include Na₂SO₄ (aq) at a concentration of up to about 288 g/kg H₂O and LiOH (aq) at a concentration of up to about 168 to 210 g/kg H₂O depending on final temperature and concentration of Na₂SO₄.

At 218, the crystallized lithium hydroxide monohydrate salt may be removed from the solution via any suitable solid-liquid separation. In examples, the solid-liquid separation may be performed using one or more hydrocyclone(s) in combination with one or more centrifuge(s). In examples, at 218, the solid-liquid separation may include washing of a filter cake obtained. In examples, the residual moisture in the lithium hydroxide monohydrate after solid-liquid separation may be in the range of about 1-5% based on total mass of the cake. In examples, the produced lithium hydroxide monohydrate is a lithium hydroxide monohydrate with a low carbonate content.

In examples, the remaining LiOH solution after the removal of the lithium hydroxide monohydrate salt at 218 may be recycled to 206. Recycling of this remainder solution can reduce lithium loss in process 200. In examples, a portion of the liquid may be purged to ensure that the concentration of impurities does not build up in the process.

In examples, the lithium hydroxide monohydrate salt or cake collected at 218 may be further processed through one or more optional repulping and separation stages to remove impurities and achieve a desired level of purity to yield a final purified lithium hydroxide monohydrate salt. If the level of purity of the lithium hydroxide monohydrate salt collected at 218 is above a desired threshold, then no repulping and separation stage is necessary and the salt from 218 may be used as the final purified lithium hydroxide monohydrate salt.

In examples, the lithium hydroxide monohydrate salt or cake collected at 218 may be processed in a first repulping stage 220. In examples, at 220, in a repulping stage 1 the lithium hydroxide monohydrate collected at 218 may be repulped with high purity water in an agitated tank to yield a first repulping solution. In this manner, the soluble impurities present in the lithium hydroxide monohydrate solids may be transferred to the added water, thereby further reducing the level of impurities that may be present in the lithium hydroxide monohydrate. In examples, the repulping stage 1 at 220 may be carried out in addition to any washing step that may have been carried out at 218 as part of the solid-liquid separation.

In examples, the repulping stage 1 at 220 may be carried out at a temperature of about 30° C. to 40° C., at atmospheric pressure. Any suitable equipment may be used for repulping. In examples, the solid to liquid ratio of the first repulping solution, i.e. at the repulping stage 1 at 220 may be 1 to 3 depending on the level of impurities and moisture present in the solids or cake obtained from. It is noted that during the repulping stage 1, some of the lithium hydroxide monohydrate may be dissolved and lost in the solution.

In examples, at 222, the lithium hydroxide monohydrate may be separated from the first repulping solution of repulping stage 1 at 220 via a first solid-liquid separation, solid-liquid separation stage 1. In examples, the solid-liquid separation stage 1 at 220 may be carried out by any suitable process. In examples, the solid-liquid separation stage 1 at 220 may be carried out with a centrifuge and/or filter. In examples, the remaining solution after the removal of the first stage repulped lithium hydroxide monohydrate may be recycled to 206. Recycling of this remainder solution can reduce lithium loss in process 200. In examples, a portion of the remaining solution may be purged to ensure that the concentration of impurities does not build up in the process. In examples, the residual moisture in the lithium hydroxide monohydrate salt after solid-liquid separation of at 222 may be in the range of 3 to 10%.

In examples, at 224, process 200 may optionally include a second repulping stage, repulping stage 2. In examples, at 224, the solid cake of the first stage repulped lithium hydroxide monohydrate from 222 may be repulped a second time with high purity water in an agitated tank. In examples, the repulping stage 2 at 224 may be carried out at a temperature of about 30° C. to 40° C., at atmospheric pressure. In examples, in this process the soluble impurities present in the lithium hydroxide monohydrate solids may be transferred to the added water, thereby reducing the level of impurities present in the solid lithium hydroxide monohydrate. In examples, the solid to liquid ratio of the second repulping solution, i.e. at the repulping stage 2 at 224 may be 1 to 3 depending on the level of impurities and moisture present in the solids or cake obtained from. It is noted that during the repulping stage 2, some of the lithium hydroxide monohydrate may be dissolved and lost in the solution.

In examples, at 226, the lithium hydroxide monohydrate may be separated from the second repulping solution of repulping stage 2 at 222 via a second solid-liquid separation, solid-liquid separation stage 2. In examples, the solid-liquid separation stage 2 at 226 may be carried out by any suitable process. In examples, the solid-liquid separation stage 2 at 226 may be carried out with a centrifuge and/or filter. In examples, the remaining solution after the removal of the second stage repulped lithium hydroxide monohydrate may be recycled to 206. Recycling of this remainder solution can reduce lithium loss in process 200. In examples, a portion of the remaining solution may be purged to ensure that the concentration of impurities does not build up in the process. In examples, the residual moisture after solid-liquid separation of at 226 may be in the range of 3 to 10%.

In examples, at 228, further purification of the crystallized lithium hydroxide monohydrate may optionally be carried out by either one or more redissolution and recrystallization processes and/or by one or more additional repulping and filtering processes until the product meets the desired battery grade specifications. In examples, where the optional second repulping process is omitted, process 228 may follow directly after 222.

In examples, the final purified lithium hydroxide monohydrate salt or cake may be battery grade. In examples, the final purified lithium hydroxide monohydrate salt or cake may have a low carbonate content of less than 2000 ppm, less than 1500 ppm, less than 1000 ppm, less than 500 ppm, or less than 100 ppm.

In examples, at 229, the final purified lithium hydroxide monohydrate battery grade salt or cake may be sent to one or more drying and packing stages.

In examples, the process 200, and every process step thereof, may be carried out in a CO₂ free or mostly free atmosphere. A CO₂ free or mostly free atmosphere may keep absorption of CO₂ from the air as low as possible. In examples, drying of the lithium hydroxide monohydrate may be performed with hot, CO₂-free air.

FIG. 2B illustrates a process 230 similar to that discussed with reference to FIG. 2A except that the hydroxide used in step 236 is barium hydroxide (Ba(OH)₂) instead of sodium hydroxide.

In examples, process 232 is the same as previously described process 202. In examples, in process 230, the dissolution at 232 may be omitted if the starting lithium feed is already a solution containing dissolved Li₂SO₄ instead of lithium carbonate. In examples, additional Li₂SO₄ solution may optionally be added at or just before 236 to the Li₂SO₄ solution produced at 232. Also, in examples, at 234 an ion exchange treatment for carbonates as previously described with reference to 204 may be utilized to purify the barium hydroxide solution prior to its utilization in the causticization process at 236.

In examples, at 236, the barium hydroxide may be added to the lithium sulfate solution produced from 232 to yield barium sulfate (BaSO₄) and an LiOH solution as shown by the following equation.

In examples, it may be possible to introduce at 236 one or more recycle solutions produced at 248, 252 and/or 256 described below.

In examples, the reaction may be carried out at a temperature ranging from 70° C. to 90° C., at atmospheric pressure. In examples, it may not be required to add an excess of barium hydroxide. In examples, the resulting solution may include LiOH in a concentration ranging from 3 wt % up to saturation. In examples, the solution may include a LiOH concentration of about 7.2 wt %.

$${Li}_{2} {SO}_{4} ( aq ) + {Ba ( OH )}_{2} ( s ) \to {BaSO}_{4} ( s ) + 2 LiOH ( aq )$$

At 240 the barium sulfate may be removed from the LiOH solution via a solid-liquid separation process. It is noted that since barium sulfate exhibits lower solubility than sodium sulfate, it can be removed via solid-liquid separation without first requiring a cooling crystallization 208 described with reference to FIG. 2A when removing the sodium sulfate. As such step 208 may be omitted when using barium hydroxide as the hydroxide instead of sodium hydroxide. In examples, any suitable solid-liquid separation may be applied. In examples, the solid-liquid separation may be carried via filtration. In examples, the filtration may be carried out using in a centrifuge. In examples, the residual moisture of the solution after solid-liquid separation may be in the range of about 30-60%. In examples, the solid-liquid separation may include one or more washing steps of the filtered solids or cake to reduce lithium losses.

In examples, the resulting LiOH solution after the removal of the barium sulfate at 240 may be used to produce lithium hydroxide monohydrate as previously described with reference to FIG. 1. In examples, at 242, the LiOH solution may be concentrated as similarly discussed with reference to process 200 at 212. As previously described, in examples, concentration may be accomplished by evaporation. In examples, the evaporation may be carried out at a temperature in the range of about 110-120° C. In examples, the concentration may be carried out at atmospheric pressure, using any suitable equipment. In examples, where multiple stages of evaporation are involved or under vacuum, the temperature range may range from about 30 to about 120° C. In examples, the evaporation may include heating the LiOH solution produced after the separation of the barium sulfate at 240 to boiling point and evaporated until reaching saturation of or just before reaching saturation of lithium hydroxide monohydrate in the concentrated solution as previously described. As a result of this concentration process, solid impurities including Li₂CO₃ may be precipitated by the following mechanisms.

$$x ( M = Fe , Al , Co , Cu , Ni , Mn , Zn , As , … ) + {y OH}^{-} ( aq ) \to {M}_{x} {OH}_{y} ( s ) or {SiO}_{2} ( s ) {Li}_{2} {CO}_{3} ( aq ) \to {Li}_{2} {CO}_{3} ( s )$$

In examples, at 244 a solid-liquid separation may be carried out after completion of the concentration at 242 as previously described with reference to process 200 at 214. As described earlier, the solid-liquid separation may be carried out by any suitable means. In examples, the solid-liquid separation may be carried out using one or more filters, thickeners, centrifuges, or any combinations of different solid-liquid separation technologies. In examples, the separated solids from 244 may be recycled to 232 so that the precipitated Li₂CO₃ can undergo dissolution again to produce more LiOH. In examples, this recycle may enhance the recovery of lithium in the process. In examples, build-up of recycled impurities in the process may be controlled by stopping the evaporation just before reaching saturation or at saturation of the lithium hydroxide monohydrate, and removing impurities formed before proceeding with the crystallization of lithium hydroxide monohydrate. Other methods may also be used.

At 246, the saturated lithium hydroxide monohydrate in the concentrated solution may be crystallized as similarly described earlier with reference to process 200 at 216. In examples, as discussed earlier, the crystallization may be achieved either by resuming the concentration process and continuing the evaporation or by cooling crystallization. If cooling crystallization is utilized the final cooling temperature may be about 23° C. to 40° C. In examples, the crystallization follows the following mechanism.

LiOH(aq)+H₂O→LiOH*H₂O(s)

At 248, the crystallized lithium hydroxide monohydrate salt may be removed from the solution via any suitable solid-liquid separation as similarly described earlier with reference to process 200 at 218. In examples, the solid-liquid separation may be performed using one or more hydrocyclone(s) in combination with one or more centrifuge(s). In examples, at 248, the solid-liquid separation may include washing of a filter cake obtained. In examples, the residual moisture in the lithium hydroxide monohydrate after solid-liquid separation may be in the range of about 1-5% based on the total mass of the cake. In examples, the produced lithium hydroxide monohydrate is a lithium hydroxide monohydrate with a low carbonate content.

In examples, the remaining LiOH solution after the removal of the lithium hydroxide monohydrate salt at 248 may be recycled to 236. Recycling of this remainder solution can reduce lithium loss in process 230. In examples, a portion of the liquid may be purged to ensure that the concentration of impurities does not build up in the process.

In examples, the lithium hydroxide monohydrate salt or cake collected at 248 may be further processed through one or more optional repulping and separation stages 250-256 to remove impurities and achieve a desired level of purity to yield a final purified lithium hydroxide monohydrate salt as previously described with reference to process 200 at 220-226. If the level of purity of the lithium hydroxide monohydrate salt collected at 248 is below a desired threshold, then no repulping and separation stage is necessary and the salt from 248 may be used as the final purified lithium hydroxide monohydrate salt.

In examples, as described earlier, at 258, further purification of the crystallized lithium hydroxide monohydrate may optionally be carried out by either one or more redissolution and recrystallization processes and/or by one or more additional repulping and filtering processes until the product meets the desired battery grade specifications.

In examples, the final purified lithium hydroxide monohydrate salt or cake may be battery grade. In examples, the final purified lithium hydroxide monohydrate salt or cake may have a low carbonate content of less than 2000 ppm, less than 1500 ppm, less than 1000 ppm, less than 500 ppm, or less than 100 ppm.

In examples, at 260, the final purified lithium hydroxide monohydrate battery grade salt or cake may be sent to one or more drying and packing stages.

In examples, the process 230, and every process step thereof, may be carried out in a CO₂ free or mostly free atmosphere. A CO₂ free or mostly free atmosphere may keep absorption of CO₂ from the air as low as possible. In examples, drying of the lithium hydroxide monohydrate may be performed with hot, CO₂-free air.

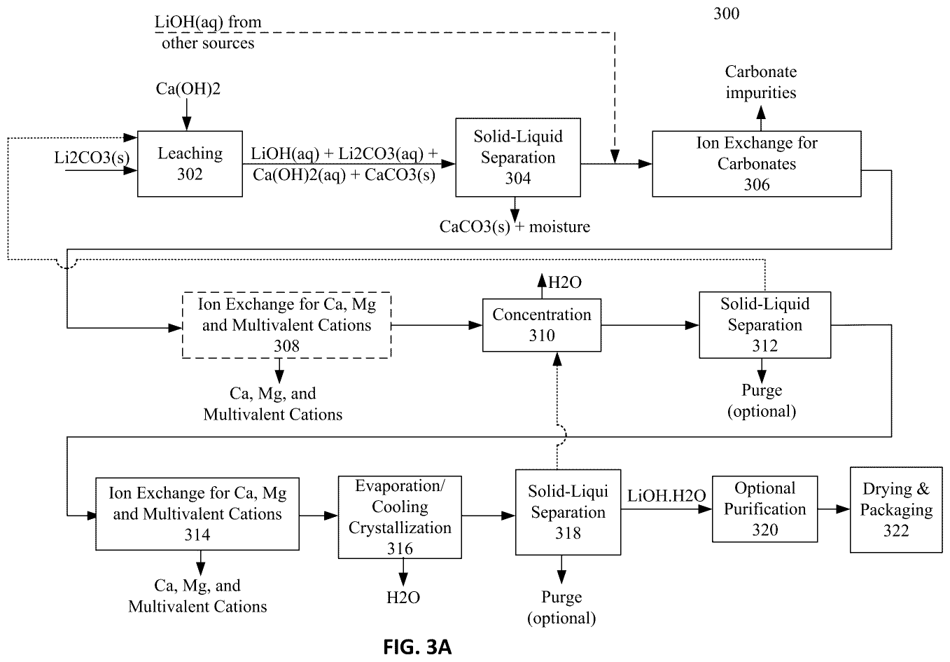

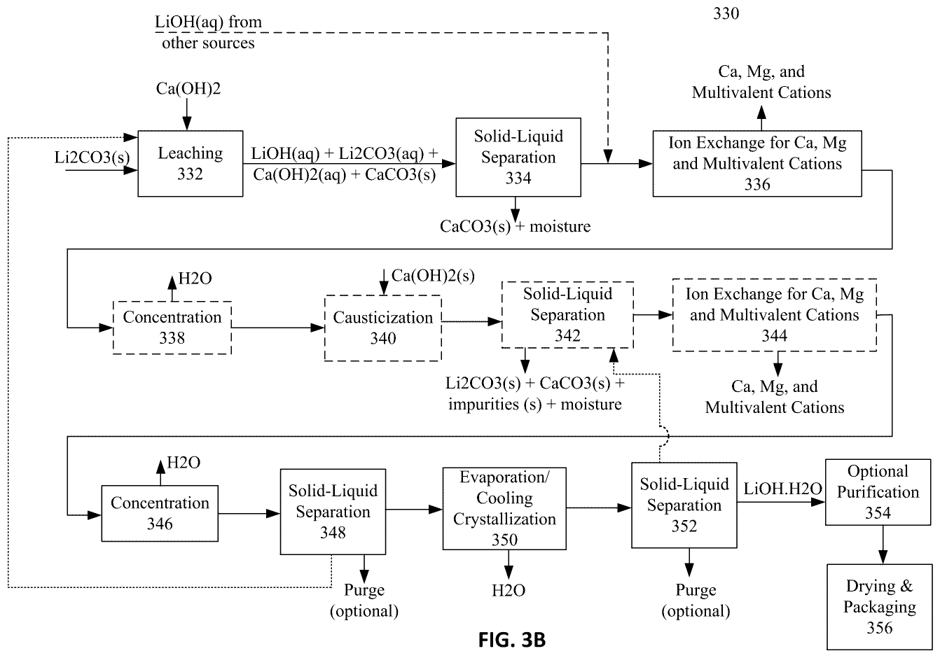

FIGS. 3A and 3B illustrate examples of a process flow diagram for producing lithium hydroxide monohydrate starting with a lithium feed of lithium carbonate the dissolution of which is carried out using an alkaline earth hydroxide. In examples, as discussed with reference to FIGS. 3A and 3B, the alkaline earth hydroxide may include calcium hydroxide (Ca(OH)₂). In examples, the process may include one or more softening treatments and ion exchange treatments to remove the unwanted carbonates and sulfates, and/or unwanted calcium, magnesium, and other multivalent cations. In examples, this process may be carried out as illustrated in FIGS. 3A and 3B.

FIG. 3A illustrates an example process 300. In examples, at 302, a feed of lithium carbonate, for example, a feed of crude lithium carbonate, may be contact with a calcium hydroxide. In examples, contact with calcium hydroxide may result in the dissolution of the lithium carbonate. In examples, the calcium hydroxide may be provided in excess ranging from 0 to 50%. In examples, the dissolution of the lithium carbonate may be carried out in a continuous stirred reactor at atmospheric pressure.

In examples, the reaction mechanism of the dissolution at 302 is shown by the following equations.

$${Li}_{2} {CO}_{3} ( s ) + {H}_{2} O \to {LiCO}_{3} ( aq )$$

$${Ca ( OH )}_{2} ( s ) + {H}_{2} O \to {Ca ( OH )}_{2} ( aq )$$

$${Li}_{2} {CO}_{3} ( aq ) + {Ca ( OH )}_{2} ( aq ) \to {CaCO}_{3} ( s ) + 2 LiOH ( aq ) + {H}_{2} O$$

In examples, as shown by the above equations, the dissolution of the lithium carbonate using an alkaline earth hydroxide such as calcium hydroxide may yield a LiOH solution containing calcium carbonate solids.

In examples, the dissolution of the lithium carbonate using an alkaline earth hydroxide such as calcium hydroxide is carried out at a temperature ranging from room temperature, i.e. about 25° C., to about 90° C. It has been found that carrying out the dissolution below room temperature may not yield an acceptable LiOH solution because of the low conversion kinetics that would be exhibited at such low temperatures. Moreover, it has been found that carrying out the dissolution above 90° C. would not likely result in the formation of solid calcium carbonate crystals having size and morphology characteristics that would render them difficult to separate from the LiOH solution resulting in higher residual moisture and consequently higher loss of lithium during solid-liquid separation.

At 304 the solid calcium carbonate may be separated from the LiOH solution formed by the dissolution of the lithium carbonate at 302. In examples, separation of the calcium carbonate may be carried out via a solid-liquid separation process. In examples, the solid-liquid separation process may be performed by any suitable means. In examples, this process may be carried out using a pressure filter. In examples, the residual moisture of the calcium carbonate cake or solids separated from the LiOH solution may be in the range of 40 to 70%.

In examples, in process 300 the dissolution and separation at 302 and 304 may be omitted if a LiOH solution is provided as the starting lithium feed instead of lithium carbonate. Any LiOH solution may be used as starting feed. In examples, the provided LiOH solution may be a crude LiOH solution, a technical grade LiOH solution, an industrial grade LiOH solution, a primary grade LiOH solution, a battery grade LiOH solution or any mixture thereof. In examples, additional LiOH solution may optionally be added at or just before 306 to the LiOH solution produced at 304.

In examples, at 306, the LiOH solution produced at 304, i.e. after the solid-liquid separation of the calcium carbonate, may be purified. In examples, the purification may include a softening of the LiOH solution. In examples, the purification of the LiOH solution at 306 may include an ion exchange treatment. In examples, the ion exchange treatment may be carried out at a temperature of about 50° C. In examples, the ion exchange treatment may include the use of any suitable resin, in examples, the resin may include a styrene resin as a polystyrene-divinylbenzene resin. In examples, the ion exchange treatment may include the use of one or more resins that may be used to remove carbonates and sulfates from the LiOH solution.

In examples, at 308, depending on the concentration of calcium, magnesium and other multivalent cations, a second ion exchange treatment may also be used with one or more resins to remove calcium, magnesium, and other multivalent cations can also be utilized for further purification. Any suitable resin for removal of divalent ions may be employed in the ion exchange treatment 308 to remove calcium, magnesium and other multivalent cations. In examples, ion exchange treatment 308 may include the use of a weak acid cation resin, for example, a resin with a carboxylic functional group such as, but not limited to, a polyacrylate microporous resin. The ion exchange treatments of 306 and 308 may thus yield a purified LiOH solution.

In examples, the purified LiOH solution may then be processed to obtain lithium hydroxide monohydrate with low carbonate content as previously described with reference to FIG. 1.

In examples, at 310, the purified LiOH solution may be concentrated. As previously described, in examples, concentration may be accomplished by evaporation. In examples, the evaporation may be carried out at a temperature in the range of about 110-120° C. In examples, the concentration may be carried out at atmospheric pressure, using any suitable equipment. In examples, where multiple stages of evaporation are involved or under vacuum, the temperature range may range from about 30 to about 120° C. In examples, the evaporation may include heating the purified LiOH solution produced at 308 to boiling point and evaporated until reaching saturation of or just before reaching saturation of lithium hydroxide monohydrate in the concentrated solution as previously described. As a result of this concentration process, solid impurities including Li₂CO₃ may be precipitated by the following mechanisms.

$$x ( M = Fe , Al , Co , Cu , Ni , Mn , Zn , As , … ) + {y OH}^{-} ( aq ) \to {M}_{x} {OH}_{y} ( s ) or {SiO}_{2} ( s ) {Li}_{2} {CO}_{3} ( aq ) \to {Li}_{2} {CO}_{3} ( s )$$

In examples, at 312 a solid-liquid separation may be carried out after completion of the concentration at 310. As previously described, the solid-liquid separation may be carried out by any suitable means. In examples, the solid-liquid separation may be carried out using one or more filters, thickeners, centrifuges, or any combinations of different solid-liquid separation technologies. In examples, the separated solids from 310 may be recycled to 302 so that the precipitated Li₂CO₃ can undergo dissolution again to produce more LiOH. In examples, this recycle may enhance the recovery of lithium in the process. In examples, build-up of recycled impurities in the process may be controlled by stopping the evaporation just before reaching saturation or at saturation of the lithium hydroxide monohydrate, and removing impurities formed before proceeding with the crystallization of lithium hydroxide monohydrate. Other methods may also be used.

In examples, some calcium hydroxide may still be present in the concentrated LiOH solution. In examples, the calcium hydroxide may be removed by employing an ion exchange treatment at 314 prior to the solid-liquid separation of the crystallized lithium hydroxide monohydrate. In examples, the ion exchange treatment may include the use of one or more resins to convert any calcium hydroxide in the solution into calcium chloride (CaCl₂)). Any suitable resin for removal of divalent ions may be employed in the ion exchange treatment 314. In examples, ion exchange treatment 314 may include the use of a weak acid cation resin, for example, a resin with a carboxylic functional group such as, but not limited to, a polyacrylate microporous resin. Due to the high degree of solubility of calcium chloride in water, in examples, the calcium chloride may be removed during the solid-liquid separation of the crystallized lithium hydroxide monohydrate by employing a washing step of the filtered lithium hydroxide monohydrate solids or cake using pure water.

At 316, after the ion exchange treatment at 314, the saturated lithium hydroxide monohydrate in the concentrated solution may be crystallized. In examples, as previously discussed, the crystallization may be achieved either by resuming the concentration process and continuing the evaporation or by cooling crystallization. If cooling crystallization is utilized the final cooling temperature may be about 23° C. to 40° C. In examples, the crystallization follows the following mechanism.

$$LiOH ( aq ) + H 2 O \to LiOH * H 2 O ( s )$$

At 318, the crystallized lithium hydroxide monohydrate salt may be removed from the solution via any suitable solid-liquid separation. In examples, the solid-liquid separation may be performed using one or more hydrocyclone(s) in combination with one or more centrifuge(s). In examples, at 318, the solid-liquid separation may include washing of a filter cake obtained. In examples, as previously discussed, the washing step may be carried out using pure water and may remove calcium chloride formed during the ion exchange treatment at 314. In examples, the residual moisture in the lithium hydroxide monohydrate after solid-liquid separation may be in the range of about 1-5% based on the total mass of the cake. In examples, the produced lithium hydroxide monohydrate is a lithium hydroxide monohydrate with a low carbonate content.

In examples, the remaining LiOH solution after the removal of the lithium hydroxide monohydrate salt at 318 may be recycled to 310. Recycling of this remainder solution can reduce lithium loss in process 300. In examples, a portion of the liquid may be purged to ensure that the concentration of impurities does not build up in the process.

In examples, at 320, optional purification of the crystallized lithium hydroxide monohydrate may be carried out by either one or more redissolution and recrystallization processes and/or by one or more additional repulping and filtering processes until the product meets the desired battery grade specifications.

In examples, at once the final purified lithium hydroxide monohydrate salt is obtained, at 322 it may be sent to one or more drying and packaging stages.

In examples, process 300 may be carried out in a CO₂ free or mostly free atmosphere, to keep absorption of CO₂ from the air as low as possible.

FIG. 3B illustrates a process 330 similar to that discussed with reference to FIG. 3A except that the carbonates are removed via a causticization process by adding calcium hydroxide before the solid-liquid separation of the crystallized lithium hydroxide monohydrate instead of by an ion exchange treatment before the concentration of the LiOH solution.

In examples, at 332 and 334 dissolution of crude lithium carbonate by a leaching process using calcium hydroxide followed by a solid-liquid separation as previously described with reference to process 300 at 302 and 304 may be carried out in the same manner to yield a LiOH solution with a residual moisture after solid-liquid separation in the range of 40-70%. In examples, in process 330 the dissolution and separation at 332 and 334 may be omitted if a LiOH solution is provided as the starting lithium feed instead of lithium carbonate. Any LiOH solution may be used as starting feed. In examples, the provided LiOH solution may be a crude LiOH solution, a technical grade LiOH solution, an industrial grade LiOH solution, a primary grade LiOH solution, a battery grade LiOH solution or any mixture thereof. In examples, additional LiOH solution may optionally be added at or just before 336 to the LiOH solution produced at 334.

In examples, at 336, the LiOH solution obtained at 334 may undergo an ion exchange treatment for removal of calcium, magnesium and other multivalent cations in a similar manner as previously described with reference to process 300 at 308. In examples, the LiOH solution produced at 334 may be purified at 336, using this ion exchange treatment that uses a resin capable of or configured to removing calcium, magnesium and other multivalent cations.

In examples, at 338 the purified LiOH solution may optionally be concentrated. In examples, the concentration may be by an evaporative process. In examples, the evaporation may be carried out to remove as much water from the solution as desired before achieving saturation or near saturation of the lithium hydroxide monohydrate. In examples, at 338, the LiOH solution may be concentrated by removal of up to one third of the water from the solution, up to one half of the water from solution, or within a range of one third to one half of the water from the solution.

In examples, once a desired concentration level has been reached at 338, at 340, the concentrated LiOH solution may optionally undergo causticization by the addition of calcium hydroxide. In examples, causticization may be carried out by adding calcium hydroxide in excess, for example from 10-30%, to promote the precipitation of calcium carbonate by increasing the calcium concentration in the solution. In examples, the temperature may remain constant throughout the process. By this process, it may be possible to remove or reduce the content of lithium carbonate present in the concentrated LiOH solution. In examples, this process may form calcium carbonate solids and additional aqueous lithium hydroxide.

$${Ca ( OH )}_{2} ( s ) + {Li}_{2} {CO}_{2} ( aq ) = {CaCO}_{3} ( s ) + 2 LIOH ( aq )$$

In examples, the calcium carbonate solids may precipitate out of solution. In examples, the aqueous lithium hydroxide may increase the concentration of the solution.

In examples, at 342, the causticized LiOH solution may optionally then undergo a solid-liquid separation for the removal of any remaining lithium carbonate and of any calcium carbonate formed at 340. In examples, at 342, the process may also precipitate metal impurities introduced by the addition of Ca(OH)₂, as well as any excess Ca(OH)₂ and some silica that may be present in the solution. In examples, the solid-liquid separation may be carried out by any suitable means. In examples, the solid-liquid separation may be carried out using one or more filters, thickeners, centrifuges, or any combinations of different solid-liquid separation technologies. In examples, the separated solids from 342 may be recycled to 332 so that the precipitated Li₂CO₃ can undergo dissolution again to produce more LiOH. In examples, this recycle may enhance the recovery of lithium in the process.

In examples, the calcium carbonate solids cake separated from the causticized LiOH solution may have a residual moisture ranging from 40 to 70% based on the total mass of the cake.

In examples, at 344, the LiOH solution produced at 342 may optionally be further purified. In examples, the purification may be a softening process. In examples, the purification may include an ion exchange treatment that uses one or more resins capable of removing calcium, magnesium and other multivalent cations. In examples, at 344, the LiOH solution produced at 342 may undergo an ion exchange treatment for removal of calcium, magnesium and other multivalent cations in a similar manner as previously described with reference to process 300 at 308

In examples, the further purified LiOH provided at 344 may be used to form the low carbonate, battery grade lithium hydroxide monohydrate as previously described with reference to FIG. 1.

In examples, the further purified LiOH solution produced at 344 or alternatively if optional processes 338 to 344 are not performed, then the purified LiOH solution produced at 336 may be used to form the lithium hydroxide monohydrate. In examples, at 346 the LiOH solution form 336 or 344 may be concentrated. As previously described, in examples, concentration may be accomplished by evaporation. In examples, the evaporation may be carried out at a temperature in the range of about 110-120° C. In examples, the concentration may be carried out at atmospheric pressure, using any suitable equipment. In examples, where multiple stages of evaporation are involved or under vacuum, the temperature range may range from about 30 to about 120° C. In examples, the evaporation may include heating the LiOH solution produced at 336 or 344 to boiling point and evaporated until reaching saturation of or just before reaching saturation of lithium hydroxide monohydrate in the concentrated solution as previously described. As a result of this concentration process, solid impurities including Li₂CO₃ may be precipitated by the following mechanisms.

$$x ( M = Fe , Al , Co , Cu , Ni , Mn , Zn , As , … ) + {y OH}^{-} ( aq ) \to {M}_{x} {OH}_{y} ( s ) or {SiO}_{2} ( s ) {Li}_{2} {CO}_{3} ( aq ) \to {Li}_{2} {CO}_{3} ( s )$$

In examples, at 348 a solid-liquid separation may be carried out after completion of the concentration at 346. As previously described, the solid-liquid separation may be carried out by any suitable means. In examples, the solid-liquid separation may be carried out using one or more filters, thickeners, centrifuges, or any combinations of different solid-liquid separation technologies. In examples, the separated solids from 346 may be recycled to 332 so that the precipitated Li₂CO₃ can undergo dissolution again to produce more LiOH. In examples, this recycle may enhance the recovery of lithium in the process. In examples, build-up of recycled impurities in the process may be controlled by stopping the evaporation just before reaching saturation or at saturation of the lithium hydroxide monohydrate, and removing impurities formed before proceeding with the crystallization of lithium hydroxide monohydrate. Other methods may also be used.

At 350, the saturated lithium hydroxide monohydrate in the concentrated solution may be crystallized. In examples, as previously discussed, the crystallization may be achieved either by resuming the concentration process and continuing the evaporation or by cooling crystallization. If cooling crystallization is utilized the final cooling temperature may be about 23° C. to 40° C. In examples, the crystallization follows the following mechanism.

$$LiOH ( aq ) + H 2 O \to LiOH * H 2 O ( s )$$

At 352, the crystallized lithium hydroxide monohydrate salt may be removed from the solution via any suitable solid-liquid separation. In examples, the solid-liquid separation may be performed using one or more hydrocyclone(s) in combination with one or more centrifuge(s). In examples, the residual moisture in the lithium hydroxide monohydrate after solid-liquid separation may be in the range of about 1-5%. In examples, the produced lithium hydroxide monohydrate is a lithium hydroxide monohydrate with a low carbonate content.

In examples, the remaining LiOH solution after the removal of the lithium hydroxide monohydrate salt at 352 may be recycled to 342. Recycling of this remainder solution can reduce lithium loss in process 330. In examples, a portion of the liquid may be purged to ensure that the concentration of impurities does not build up in the process.

In examples, at 354, optional purification of the crystallized lithium hydroxide monohydrate may be carried out by either one or more redissolution and recrystallization processes and/or by one or more additional repulping and filtering processes until the product meets the desired battery grade specifications.

In examples, once the final purified lithium hydroxide monohydrate salt is obtained, at 356 it may be sent to one or more drying and packaging stages.

In examples, process 330 may be carried out in a CO₂ free or mostly free atmosphere, to keep absorption of CO₂ from the air as low as possible.

In examples, the process 300 and 330 as described with reference to FIGS. 3A and 3B may be modified by starting with providing a LiOH solution instead of a lithium carbonate feed. In examples, if a LiOH solution were provided, there would be no need to produce a LiOH solution from a lithium carbonate feed. In examples, the process 300 and 330 respectively may be carried out in the same manner as described above except for the omission of the dissolution of lithium carbonate using an alkaline earth hydroxide such as calcium hydroxide and the separation of the precipitated alkaline earth carbonate, such as the calcium carbonate at the beginning of each process (i.e. steps 302 and 304 for process 300 and steps 332 and 334 for process 330).

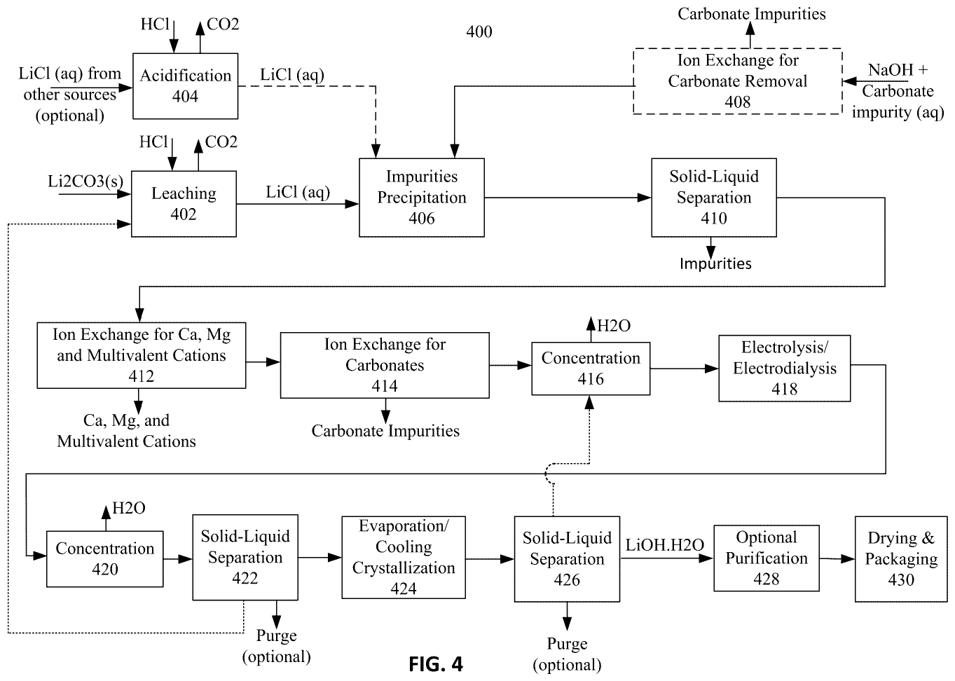

FIG. 4 illustrates an example of a process flow diagram for producing battery grade, low carbonate, lithium hydroxide monohydrate starting with a lithium feed of either lithium carbonate or an aqueous lithium chloride solution. In examples, where the lithium feed includes lithium carbonate, the process may include a dissolution of the lithium carbonate using an acid. In examples, the acid used may be hydrochloric acid (HCl). In examples, where the lithium feed includes an aqueous lithium chloride solution, the process may include adding an acid, such as hydrochloric acid to lower the pH of the solution and then heating the solution to eliminate carbonates as CO₂ as described below. In examples, independent of the starting lithium feed, the process may include producing an LiOH solution by an electrolysis/electrodialysis process.

In examples, a process 400 illustrated in FIG. 4 may include providing a lithium feed at 402.

In examples, the lithium feed may include lithium carbonate, for example a feed of crude lithium carbonate. In this case, at 402, a dissolution of the crude lithium carbonate may be carried out by contacting the lithium carbonate with excess HCl. In examples, the HCl can be provided in an excess amount in the range of about 0 to 10%. In examples, this dissolution may be carried out in a continuous stirred tank reactor. In examples, this dissolution may be conducted at atmospheric pressure. In examples, the dissolution may be carried out at a temperature in the range of 70° C. to 90° C. In examples, the dissolution mechanism may follow the following equation.

$${Li}_{2} {CO}_{3} ( s ) + 2 HCl ( aq ) \to 2 LiCl ( aq ) + {CO}_{2} ( g ) + {H}_{2} O$$

In examples, the dissolution process yields a LiCl aqueous solution. It is note that during this dissolution process, the CO2 solubility is maintained low because of the temperature at which the solution is maintained.

In examples, the lithium feed provided in process 400 may be an aqueous lithium chloride solution instead of a lithium carbonate feed. In examples, the lithium feed may include a crude lithium chloride, a technical grade lithium chloride, an industrial grade lithium chloride, a primary grade lithium chloride, a battery grade lithium chloride, a lithium chloride containing impurities, or any combination thereof. In examples, where an aqueous lithium chloride solution is provided as the lithium feed, the process may proceed to 404 instead of 402. In examples, at 402, hydrochloric acid may be added to the aqueous lithium chloride solution to lower the pH, and the resultant solution can then be heated to about 70-90° C. to eliminate, reduce, and/or lower the solubility of carbonates as CO₂. In this manner, the solution achieved at 404 may be similar to the one obtained by dissolving crude Li₂CO₃ at 402.

In examples, the lithium chloride solution obtained from either the dissolution of lithium carbonate at 402 or from the heating and pH adjustment at 404 may be purified. In examples at 406, impurities in the lithium chloride solution may be precipitated by adding a hydroxide. In examples, the hydroxide may be NaOH or Ca(OH)₂. In examples, the hydroxide may react with the impurities in accordance with the following equation.

$$x ( M = Fe , Al , Co , Cu , Ni , Mn , Zn , As , … ) + {y OH}^{-} ( aq ) \to {M}_{x} {OH}_{y} ( s ) or {SiO}_{2} ( s )$$

In examples, prior to introducing it at 406, at 408 the sodium hydroxide solution may optionally be purified using an ion exchange resin capable of or configured to carbonate removal.

In examples, at 410, the solids precipitated from the addition of the hydroxide to the lithium chloride solution at 406 may be removed to yield a purified lithium chloride solution. In examples, the solids may be removed by a solid-liquid separation. In examples, any suitable solid-liquid separation may be utilized. In examples, the solid-liquid separation may be carried out by filtration and/or centrifugation.

In examples, the purified lithium chloride solution from 410 may undergo further purifications to remove calcium, magnesium, and other multivalent cations, and/or to remove any carbonates and/or sulphates.

In examples, at 412, the purified lithium chloride solution from 410 may undergo an ion exchange treatment using a resin capable of or configured to removing calcium, magnesium, and other multivalent cations. In examples, ion exchange treatment at 412 may include the use of a weak acid cation resin, for example, a resin with a carboxylic functional group such as, but not limited to, a polyacrylate microporous resin.

In examples, at 414, the further purified lithium chloride solution from 412 may be treated by ion exchange using a resin capable of or configured to removing carbonates and/or sulphates. In examples, the ion exchange treatment at 414 may include the use of any suitable resin, in examples, the resin may include a styrene resin as a polystyrene-divinylbenzene resin.

Once the lithium chloride solution has been sufficiently purified by one or more processes at 410, 412, and 414, it may be used to form the lithium hydroxide monohydrate.

In examples, at 416, the post-purification lithium chloride solution may be concentrated. In examples, post concentration the solution may have a lithium chloride concentration ranging from about 4 wt % to about 13 wt %. In examples, the concentration process may include reverse osmosis (RO). In examples, the concentration process may include evaporation. In examples, the RO may be carried out at ambient temperature under osmotic pressure. The concentration achieved may depend on the osmotic pressure applied. In examples, evaporation may be used to concentrate the solution up to saturation over a variable temperature range. In examples, evaporation may provide greater control over the concentration process.

In examples, at 418, the concentrated lithium chloride solution may be converted to a lithium hydroxide solution via an electrolysis/electrodialysis process. In this manner, at 418 it is possible to obtain a concentrated LiOH solution.

In examples, at 420, the further LiOH solution may be further concentrated to obtain a concentrated lithium hydroxide solution saturated or nearly saturated with lithium hydroxide monohydrate. As previously described, in examples, concentration may be accomplished by evaporation. In examples, the evaporation may be carried out at a temperature in the range of about 110-120° C. In examples, the concentration may be carried out at atmospheric pressure, using any suitable equipment. In examples, where multiple stages of evaporation are involved or under vacuum, the temperature range may range from about 30 to about 120° C. In examples, the evaporation may include heating the concentrated LiOH solution produced at 418 to boiling point and evaporate until reaching saturation of or just before reaching saturation of lithium hydroxide monohydrate in the concentrated solution as previously described. As a result of this concentration process, solid impurities including Li₂CO₃ may be precipitated by the following mechanisms.

$$x ( M = Fe , Al , Co , Cu , Ni , Mn , Zn , As , … ) + {y OH}^{-} ( aq ) \to {M}_{x} {OH}_{y} ( s ) or {SiO}_{2} ( s ) {Li}_{2} {CO}_{3} ( aq ) \to {Li}_{2} {CO}_{3} ( s )$$

In examples, at 422 a solid-liquid separation may be carried out after completion of the concentration at 420. As previously described, the solid-liquid separation may be carried out by any suitable means. In examples, the solid-liquid separation may be carried out using one or more filters, thickeners, centrifuges, or any combinations of different solid-liquid separation technologies. In examples, the separated solids from 422 may be recycled to 402 so that the precipitated Li₂CO₃ can undergo dissolution again to produce more LiCl and ultimately more LiOH. In examples, this recycle may enhance the recovery of lithium in the process. In examples, build-up of recycled impurities in the process may be controlled by stopping the evaporation just before reaching saturation or at saturation of the lithium hydroxide monohydrate, and removing impurities formed before proceeding with the crystallization of lithium hydroxide monohydrate. Other methods may also be used.

In examples, at 424, the saturated lithium hydroxide monohydrate in the concentrated LiOH solution may be crystallized. In examples, as previously discussed, the crystallization may be achieved either by a concentration evaporative process or by cooling crystallization. If cooling crystallization is utilized the final cooling temperature may be about 23° C. to 40° C. In examples, the crystallization follows the following mechanism.

$$LiOH ( aq ) + H 2 O \to LiOH * H 2 O ( s )$$

At 426, the crystallized lithium hydroxide monohydrate salt may be removed from the solution via any suitable solid-liquid separation. In examples, the solid-liquid separation may be performed using one or more hydrocyclone(s) in combination with one or more centrifuge(s). In examples, the residual moisture in the lithium hydroxide monohydrate cake after solid-liquid separation may be in the range of about 1-5% based on the total mass of the cake. In examples, the produced lithium hydroxide monohydrate is a lithium hydroxide monohydrate with a low carbonate content.

In examples, the remaining LiOH solution after the removal of the lithium hydroxide monohydrate salt at 424 may be recycled to the concentration process at 416. Recycling of this remainder solution can reduce lithium loss in process 400. In examples, a portion of the liquid may be purged to ensure that the concentration of impurities does not build up in the process.

In examples, at 428, optional purification of the crystallized lithium hydroxide monohydrate may be carried out by either one or more redissolution and recrystallization processes and/or by one or more additional repulping and filtering processes until the product meets the desired battery grade specifications.

In examples, once the final purified lithium hydroxide monohydrate salt is obtained, at 430 it may be sent to one or more drying and packaging stages.

In examples, process 400 may be carried out in a CO₂ free or mostly free atmosphere, to keep absorption of CO₂ from the air as low as possible.

One or more of the purifications in process 400 as described above can be omitted depending on the level of impurities in the system, and the concentration of the lithium chloride solution.

In examples, as described above with reference to FIGS. 1-4, liquids produced during any of the described solid-liquid separations may be recycled back into the respective processes.

In examples, the systems described herein may include one or more control systems, sensors, and other standard components that allow for the control and operation thereof.

In examples, although not shown, the systems described herein may include one or more sensors as generally employed in the art. In examples, sensors may be used to monitor the operation of the systems described. Non-limiting examples of one or more sensors may include temperature sensors, pressure sensors, flow meters, pH meter, and other like sensors.

In examples, although not shown, the one or more control systems may include one or more controllers and/or other suitable computing devices may be employed to control one or more of portions of systems described herein. Controllers may include one or more processors and memory communicatively coupled with each other. In the illustrated example, a memory may be used to store logic instructions to operate and/or control and/or monitor the operation of the process described. In examples, the controllers may include or be coupled to input/output devices such as monitors, keyboards, speakers, microphones, computer mouse and the like. In examples, the one or more controllers may also include one or more communication components such as transceivers or like structure to enable wired and/or wireless communication. In examples, this may allow for remote operation of one or more systems described herein.

In examples, memory associated with the one or more controllers and/or other suitable computing devices may be non-transitory computer-readable media. The memory may store an operating system and one or more software applications, instructions, programs, and/or data to implement the methods described herein and the functions attributed to the various systems. In various implementations, the memory may be implemented using any suitable memory technology, such as static random-access memory (SRAM), synchronous dynamic RAM (SDRAM), nonvolatile/Flash-type memory, or any other type of memory capable of storing information. The controls systems may include any number of logical, programmatic, and physical components.

Logic instructions may include one or more software modules and/or other sufficient information for autonomous operation, safety procedures, and routine maintenance processes. Any operation of the described system may be implemented in hardware, software, or a combination thereof. In the context of software, operations represent computer-executable instructions stored on one or more computer-readable storage media that, when executed by one or more processors, perform the recited operations. Generally, computer-executable instructions include routines, programs, objects, components, data structures, and the like that perform one or more functions or implement particular abstract data types.

It will be apparent to those skilled in the art that various modifications and variation can be made in the present disclosure without departing from the spirit or scope of the disclosure. Thus, it is intended that the present disclosure cover the modifications and variations of this disclosure provided they come within the scope of the appended claims and their equivalents.

What is claimed is:

1. A process for producing lithium hydroxide monohydrate comprising:
forming a concentrated lithium hydroxide solution saturated or nearly saturated with lithium hydroxide monohydrate;
removing at least some lithium carbonate from the concentrated lithium hydroxide solution via a first solid-liquid separation process;
crystallizing the lithium hydroxide monohydrate in the concentrated lithium hydroxide solution; and
separating the crystallized lithium hydroxide monohydrate from the concentrated lithium hydroxide solution via a second solid-liquid separation process.

2. The process of claim 1, wherein forming the concentrated lithium hydroxide solution further comprises providing a lithium containing feed.

3. The process of claim 2, wherein the providing a lithium containing feed comprises providing a lithium sulfate solution.

4. The process of claim 3, further comprising reacting the lithium sulfate solution with a hydroxide.

5. The process of claim 4, wherein the hydroxide is sodium hydroxide and further comprising:
producing aqueous sodium sulfate;
conducting a cooling crystallization process to crystallize the aqueous sodium sulfate to yield Glauber Salt; and
separating the Glauber Salt from the lithium hydroxide solution via a third solid-liquid separation process to yield a purified lithium hydroxide solution.

6. The process of claim 5, wherein forming the concentrated lithium hydroxide solution saturated or nearly saturated with lithium hydroxide monohydrate comprises concentrating the purified lithium hydroxide solution.

7. The process of claim 6, wherein concentrating the lithium hydroxide solution comprises an evaporative process.

8. The process of claim 5, wherein the hydroxide comprises barium hydroxide and further comprising:
producing solid barium sulfate; and
separating the solid barium sulfate from the lithium hydroxide solution via a second solid-liquid separation process to yield a purified lithium hydroxide solution.

9. The process of claim 8, wherein forming the concentrated lithium hydroxide solution saturated or nearly saturated with lithium hydroxide monohydrate comprises concentrating the purified lithium hydroxide solution.

10. The process of claim 9, wherein concentrating the lithium hydroxide solution comprises an evaporative process.

11. The process of claim 3, wherein the providing the lithium sulfate solution comprises:
providing a lithium containing feed comprising a lithium carbonate; and
reacting the lithium carbonate with sulfuric acid to produce the lithium sulfate solution.

12. The process of claim 1, wherein crystallizing the lithium hydroxide monohydrate comprises further concentrating the concentrated lithium hydroxide solution by evaporation.

13. The process of claim 1, wherein crystallizing the lithium hydroxide monohydrate comprises cooling crystallization.

14. The process of claim 13, wherein forming a concentrated lithium hydroxide solution saturated or nearly saturated with lithium hydroxide monohydrate comprises conducting an evaporative process.

15. The process of claim 14, further comprising employing a heat pump arranged to provide cooling for the cooling crystallization and heating for the evaporative process.

16. The process of claim 1, further comprising one or more purifications of the crystallized lithium hydroxide monohydrate separated from the concentrated lithium hydroxide solution.

17. The process of claim 1, further comprising drying and packaging the crystallized lithium hydroxide monohydrate separated from the concentrated lithium hydroxide solution.

18. The process of claim 1, further comprising recycling the concentrated lithium hydroxide solution after separation of the crystallized lithium hydroxide monohydrate to produce additional lithium hydroxide monohydrate.
